(19) United States
(12) Patent Application Publication
(10) Pub. No.: US 2023/0150709 A1
(43) Pub. Date: May 18, 2023

(54) LABEL APPLYING SYSTEM

(71) Applicant: ID Technology LLC, Ft. Worth, TX (US)

(72) Inventors: Ronald Lee SCHMOKER, Littleton, CO (US); Truman James GIESEN, Denver, CO (US); Kyle Austin PARIS, Littleton, CO (US); Corbin Henry BAIRD, Highlands Ranch, CO (US)

(21) Appl. No.: 17/986,284

(22) Filed: Nov. 14, 2022

Related U.S. Application Data
(60) Provisional application No. 63/280,199, filed on Nov. 17, 2021.

(51) Int. Cl. B65C 9/30; B65C 9/02

(52) U.S. Cl. CPC B65C 9/30; B65C 9/02

(57) ABSTRACT

A label applying system includes a conveyance path for moving items in a conveyance direction and a label applying arm movable in one of a vertical direction or a horizontal direction relative to the conveyance path for applying labels to moving items. A bearing system is provided for supporting movement of the label applying arm, the bearing system including a first bearing having a first rolling surface engaged with a first external surface portion the label applying arm and a second bearing having a second rolling surface engaged with a second external surface portion of the label applying arm, wherein the first bearing includes a first rotational axis that extends at a first oblique angle relative to the conveyance direction, wherein the second bearing includes a second rotational axis that extends at a second oblique angle relative to the conveyance direction.

### TECHNICAL FIELD

The present application relates generally to label applying and, more particularly, to a label applying system for labeling the tops or sides of items as the items are conveyed along a path.

### BACKGROUND

Material handling systems are used in many different industries and often include complex packaging and conveyor systems that convey items, such as cases (boxes), quickly from one place to the next within a facility or multiple facilities. Labeling is often necessary to communicate information about the cases so that the cases can be identified, categorized, and/or properly routed, among other reasons. One type of known system uses on overhead label applier.

In one type of overhead label applier, the applier includes an applying arm with a label retention face at its lower end. After the label retention face receives a label, the label applying arm is driven linearly downward to move the label into contact with the top of an item moving along a conveyance path. The contact between the label applier and the moving item creates a torque force on the label applying arm.

The prior art label applying system of FIGS. 1 and 2 includes a label applying arm 10 with a rectangular tubular form. A drive gear 12 engages with a gear track 14 on the side of the label applying arm to move the arm up and down. The item conveyance direction is depicted by arrow 16. Upper bearings 18 and lower bearings 20 are provided on opposed sides of the arm, and upper bearing 22 and lower bearing 24 are provided on the downstream side of the arm, such that the bearings help to stabilize the arm. An exemplary torque force on the label applying arm is shown by arrow 26. Notably, the bearings 18 and 20 are oriented with rotational axes substantially parallel to the item conveyance direction, and therefore the bearings 18 and 20 do not take up any of the torque force. This results in the torque force 26 being taken up by the lower bearing 24 at the downstream side of the arm and the upper bearing 22. Over time, this causes excessive wear on the bearings 22 and 24, which results in a need for regular adjustment of the bearing system and/or replacement of the bearings 22 and 24.

It would be desirable to provide a label applying system that addresses the above issue.

### SUMMARY

In one aspect, a label applying system includes a conveyance path for moving items in a conveyance direction and a label applying arm movable in one of a vertical direction or a horizontal direction relative to the conveyance path for applying labels to moving items. A bearing system is provided for supporting movement of the label applying arm, the bearing system including a first bearing having a first rolling surface engaged with a first external surface portion the label applying arm and a second bearing having a second rolling surface engaged with a second external surface portion of the label applying arm, wherein the first bearing includes a first rotational axis that extends at a first oblique angle relative to the conveyance direction, wherein the second bearing includes a second rotational axis that extends at a second oblique angle relative to the conveyance direction.

In another aspect, a label applying system includes a conveyance path for moving items in a conveyance direction, and a label applying arm movable relative to the conveyance path for applying labels to moving items, the label applying arm carrying a gear track that is engaged by a drive gear for moving the label applying arm, wherein the drive gear includes a rotational axis. A bearing system for supporting movement of the label applying arm, the bearing system including a first bearing having a first rolling surface engaged with a first external surface portion the label applying arm and a second bearing having a second rolling surface engaged with a second external surface portion of the label applying arm, wherein the first bearing includes a first rotational axis, wherein the second bearing includes a second rotational axis. In a view looking along a length of the label applying arm, the rotational axis of the drive gear, the first rotational axis of the first bearing and the second rotational axis of the second bearing intersect to form a triangular shape.

In another aspect, a label applying system includes a conveyance path for moving items in a conveyance direction, and a label applying arm movable relative to the conveyance path for applying labels to moving items on the conveyance path, wherein the label applying arm has a hexagonal tubular shape comprising six flat segments. A bearing system supports movement of the label applying arm, the bearing system including a first bearing having a first rolling surface engaged with a first one of the six flat segments and a second bearing having a second rolling surface engaged with a second one of the six flat segments. A plane in which the first one of the six flat segments lies is oriented so as to not run parallel or perpendicular to the conveyance direction, and a plane in which the second one of the six flat segments lies is oriented so as to not run parallel or perpendicular to the conveyance direction.

The details of one or more embodiments are set forth in the accompanying drawings and the description below. Other features, objects, and advantages will be apparent from the description and drawings, and from the claims.

### BRIEF DESCRIPTION OF THE DRAWINGS

FIGS. 1 and 2 are views of a prior art overhead label applying system;

FIGS. 3-4 show side elevation cross-section views of a label applying system of the present application; and

FIGS. 5 and 6 show top plan views of the label applying system, with FIG. 5 in cross-section;

FIG. 7 shows an alternative embodiment of the label applying system oriented for applying labels to the sides of moving items; and

FIG. 8 shows an alternative embodiment of the label applier, incorporating three upper bearings and three lower bearings.

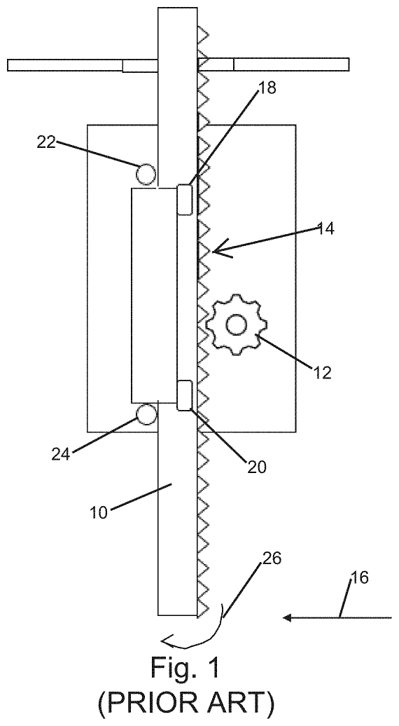

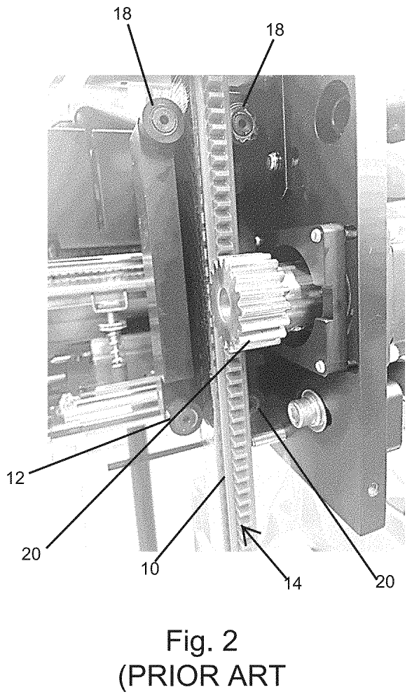

### DETAILED DESCRIPTION

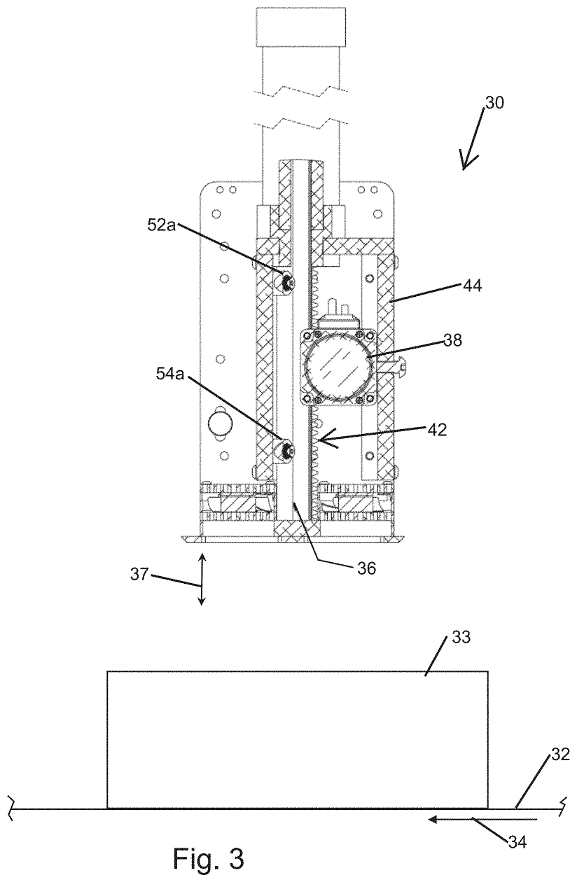

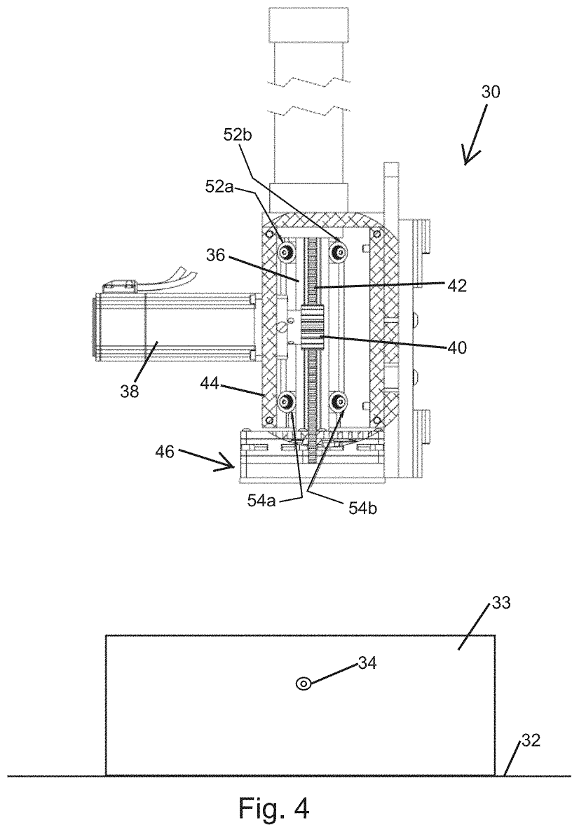

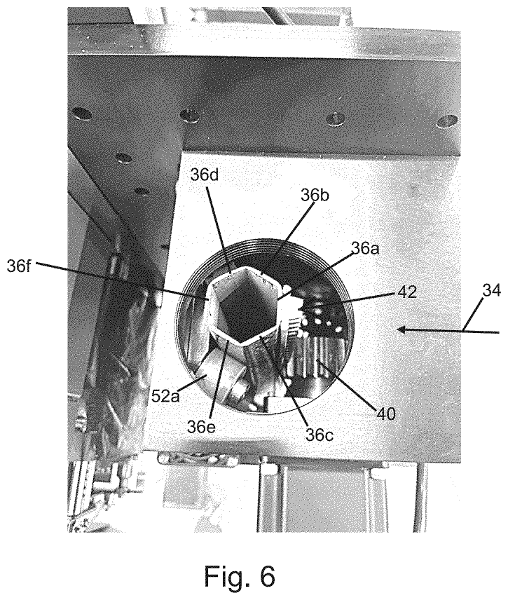

Referring to FIGS. 3-6, a label applying system 30 includes a conveyance path 32 for moving items 33 in a conveyance direction 34. Here, the label applier is arranged vertically above the conveyance path. A label applying arm 36 is mounted above the conveyance path 32 and is movable in a vertical direction up and down, per arrow 37, relative to the conveyance path 32 for applying labels to the top panel or wall of moving items 33. A drive motor 38 drives a drive gear 40 that engages a gear track 42 on the arm for the purpose of arm movement. The drive motor 38 extends externally of a support housing 44, and the drive gear 40 is internal of the support housing, as is at least part of the arm 36 and track 42. A label holding and applying head 46 is connected to the bottom of the label applying arm 36 and moves with the arm. The head 46 may, for example, include vacuum means for holding a label with adhesive side facing down toward the conveyance path 32.

A bearing system is provided for supporting movement of the label applying arm 36. The bearing system includes upper bearings 52a, 52b and lower bearings 54a, 54b having rolling surfaces engaged with external surface portions of the label applying arm. The upper bearings 52a, 52b have rotational axes 56a, 56b that extend at oblique angles a and b relative to the conveyance direction 34. The rotational axis of lower bearing 54a runs substantially parallel to that of upper bearing 52a, and the rotational axis of lower bearing 54b runs substantially parallel to that of upper bearing 54b.

The label applying arm 36 is of tubular form and includes multiple flat segments. Here, the form is hexagonal, and six flat segments 36a-36f are provided, and the tube may be of carbon fiber material. Flat segment 36a carries the gear track 42. Flat segments 36b and 36c extend from opposite sides of the flat segment 36a and do not engage with any bearings. Flat segment 36d extends from the flat segment 36b, and each of the bearings 52b and 54b engage with the external surface of flat segment 36d. Flat segment 36e extends from the flat segment 36c, and each of the bearings 52a and 54a engage with the external surface of flat segment 36e. The flat segment 36f extends between segments 36d and 36e and does not engage with any bearings. Each of the flat segments 36d and 36e lies in a plane that runs substantially parallel to the respective bearing rotational axes 56a and 56b, and therefore is no parallel or perpendicular to the conveyance direction 34.

The resulting arrangement provides a system in which bearings 52a and 54a have respective rotational axes that extend at an angle a relative to the conveyance direction 34, and in which bearings 52b and 54b have respective rotational axes that extend at an angle b relative to the conveyance direction. Here, the angles a and b are substantially the same and approximately thirty degrees. However, variations are possible, such as angles a and b being at least twenty-five degrees (e.g., between twenty-five degrees and thirty-five degrees), or at least twenty degrees (e.g., between twenty degrees and forty degrees). The rotational axes 56a and 56b intersect at an angle c that is less than ninety degrees, in particular less than seventy degrees, such as between fifty-five and sixty-five degrees (e.g., about sixty degrees).

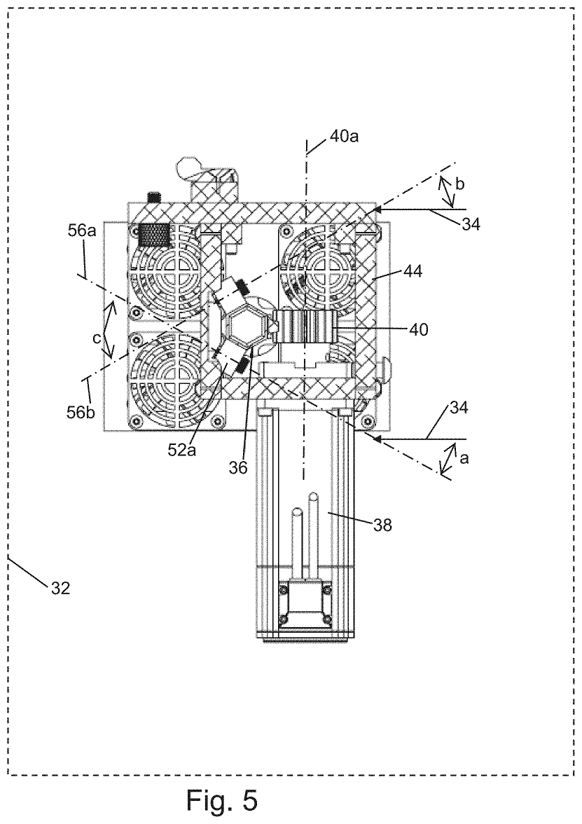

In addition, the drive gear 40 includes a rotational axis 40a, and, in plan view looking along a length of the label applying arm per FIG. 5, the rotational axis 40a of the drive gear, the rotational axes (e.g., 56a) of the bearings 52a, 54a and the rotational axes (e.g., 56b) of the bearings 52b, 54b intersect (e.g., axes 56a and 56b intersect each other and also each intersect with axes 40a) to form a triangular shape 57.

With the rotational axes of the bearings offset from the conveyance direction, the above-described setup is advantageous as compared to the described prior art system. In particular, the inventive system of this application includes: 2 upper and lower bearings providing support vs 1 upper and lower in the prior art, totaling 4 bearings to take up the arm torque vs 2 on the prior art design; a hexagon shape tubular arm that provides a straighter surface for the bearings; a hexagon shape and bearing orientation that lessens the opportunity for rotation of the applying arm; a hexagon shape tubular arm that provides improved strength based on bearing orientation in relation to the gear creating a triangular orientation of bearings and gear; and a bearing orientation that allows for better and easier alignment with the hexagon carbon fiber tube vs the square or rectangle tube designs.

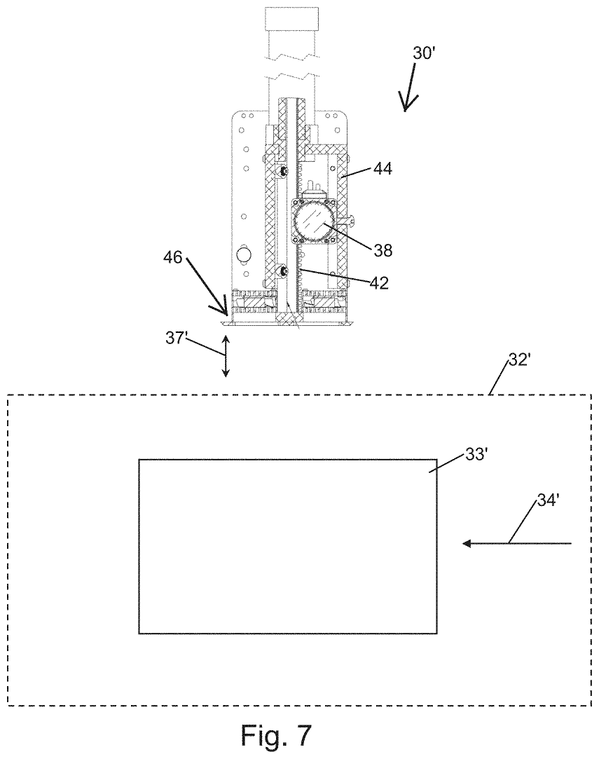

In an alternative configuration of a label applying system 30′, represented schematically in FIG. 7, the label applier is arranged alongside the conveyance path 32′, and the label applying arm moves horizontally, inward toward the path 32′ and outward away from the path 32′ per arrow 37′, for the purpose of applying labels to a side panel or wall of items 33′ moving in a conveyance direction 34′ along the path.

The foregoing is provided for purposes of illustrating, explaining, and describing embodiments of labeling apparatus. Modifications and adaptations to these embodiments will be apparent to those skilled in the art and may be made without departing from the scope or spirit of this application.

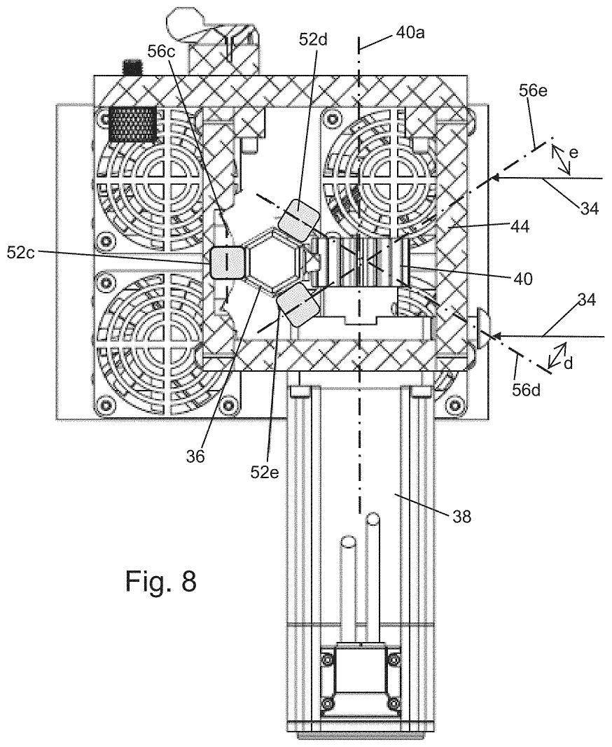

For example, referring to FIG. 8, an alternative embodiment of the label applier, which could be used in system 30 or system 30′ above, is shown, where like components are labeled as above, such as conveyance direction 34, hex arm 36, motor 38, gear 40, axis 40a, gear track 42 and housing 44. Hear, three different upper bearings 52c, 52d and 52e are provided and a similarly arranged set of lower bearings (not shown are provided). The bearings 52d and 52e are arranged in positions ninety degrees opposite to the bearings 52a and 52b of the system 30. However, bearings 52d and 52e have rotational axes 56d and 56e that are offset from the conveyance direction 34 at angles d and e that are substantially the same and approximately thirty degrees. However, variations are possible, such as angles d and e being at least twenty-five degrees (e.g., between twenty-five degrees and thirty-five degrees), or at least twenty degrees (e.g., between twenty degrees and forty degrees). This three upper bearing, three lower bearing arrangement would provide advantages similar to those described for the above two upper bearing, two lower bearing arrangement. Here, bearing 52c, which has a rotational axis 56c running substantially perpendicular to the conveyance direction 34, would oppose any force applied from the motor/drive gear, but it would eliminate any forces being applied to the motor/drive gear from the label applying arm 36 and head impacting the item being labeled. The rotational axes 56d, 56e and 50a also intersect to form a triangular shape.

Still other variations are possible.

1. A label applying system, comprising:
a conveyance path for moving items in a conveyance direction;
a label applying arm movable relative to the conveyance path for applying labels to moving items on the conveyance path;
a bearing system for supporting movement of the label applying arm, the bearing system including a first bearing having a first rolling surface engaged with a first external surface portion the label applying arm and a second bearing having a second rolling surface engaged with a second external surface portion of the label applying arm, wherein the first bearing includes a first rotational axis that extends at a first oblique angle relative to the conveyance direction, wherein the second bearing includes a second rotational axis that extends at a second oblique angle relative to the conveyance direction.

2. The system of claim 1,
wherein the label applying arm is of tubular form comprising at least a first flat segment and a second flat segment;
wherein the first external surface portion is an external surface of the first flat segment;
wherein the second external surface portion is an external surface of the second flat segment.

3. The system of claim 1,
wherein the label applying arm has a hexagonal tubular shape comprising first, second, third, fourth, fifth and sixth flat segments;
wherein the first flat segment carries a gear track;
wherein the second flat segment and the third flat segment each extend from opposite sides of the first flat segment and do not engage with any bearing;
wherein the fourth flat segment extends from the second flat segment, wherein the first external surface portion is an external surface of the fourth flat segment;
wherein the fifth flat segment extends from the third flat segment, wherein the second external surface portion is an external surface of the fifth flat segment;
wherein the sixth flat segment extends between the fourth flat segment and the fifth flat segment and does not engage with any bearing.

4. The system of claim 1,
wherein the label applying arm has a hexagonal tubular shape comprising first, second, third, fourth, fifth and sixth flat segments;
wherein the first flat segment carries a gear track;
wherein the second flat segment and the third flat segment each extend from opposite sides of the first flat segment, and do not engage with any bearing;
wherein the first external surface portion is an external surface of the second flat segment;
wherein the second external surface portion is an external surface of the fifth third segment.

5. The system of claim 4,
wherein the fourth flat segment extends from the second flat segment and does not engage with any bearing;
wherein the fifth flat segment extends from the third flat segment and does not engage with any bearing;
wherein the sixth flat segment extends between the fourth flat segment and the fifth flat segment and engages with a third bearing having a third rotational axis that is substantially perpendicular to the conveyance direction.

6. The system of claim 1,
wherein the first oblique angle is at least twenty degrees;
wherein the second oblique angle is at least twenty degrees.

7. The system of claim 6,
wherein the first oblique angle is at least twenty-five degrees;
wherein the second oblique angle is at least twenty-five degrees.

8. The system of claim 1,
wherein the bearing system further includes a third bearing having a third rolling surface engaged with the first external surface portion the label applying arm and a fourth bearing having a fourth rolling surface engaged with the second external surface portion of the label applying arm, wherein the third bearing includes a third rotational axis that extends substantially parallel to the first rotational axis, wherein the fourth bearing includes a fourth rotational axis that extends substantially parallel to the second rotational axis.

9. The system of claim 8,
wherein the third bearing is located vertically above the first bearing and the fourth bearing is located vertically above the second bearing.

10. The label applying system of claim 1, wherein the label applying arm is oriented for movement substantially horizontally toward and away from items on the conveyance path.

11. The label applying system of claim 1, wherein the label applying arm is oriented for movement substantially vertically toward and away from items on the conveyance path.

12. A label applying system, comprising:
a conveyance path for moving items in a conveyance direction;
a label applying arm movable relative to the conveyance path for applying labels to moving items, the label applying arm carrying a gear track that is engaged by a drive gear for moving the label applying arm, wherein the drive gear includes a rotational axis;
a bearing system for supporting movement of the label applying arm, the bearing system including a first bearing having a first rolling surface engaged with a first external surface portion the label applying arm and a second bearing having a second rolling surface engaged with a second external surface portion of the label applying arm, wherein the first bearing includes a first rotational axis, wherein the second bearing includes a second rotational axis;
wherein, in a view looking axially along a length of the label applying arm, the rotational axis of the drive gear, the first rotational axis of the first bearing and the second rotational axis of the second bearing intersect to form a triangular shape.

13. The label applying system of claim 12, wherein the label applying arm is oriented for movement substantially horizontally toward and away from items on the conveyance path.

14. The label applying system of claim 12, wherein the label applying arm is oriented for movement substantially vertically toward and away from items on the conveyance path.

15. A label applying system, comprising:
a conveyance path for moving items in a conveyance direction;
a label applying arm movable relative to the conveyance path for applying labels to moving items on the conveyance path, wherein the label applying arm has a hexagonal tubular shape comprising six flat segments;
a bearing system for supporting movement of the label applying arm, the bearing system including a first bearing having a first rolling surface engaged with a first one of the six flat segments and a second bearing having a second rolling surface engaged with a second one of the six flat segments, wherein a plane in which the first one of the six flat segments lies is oriented so as to not run parallel or perpendicular to the conveyance direction, wherein a plane in which the second one of the six flat segments lies is oriented so as to not run parallel or perpendicular to the conveyance direction.
